(19) United States
(12) Patent Application Publication
(10) Pub. No.: US 2024/0047998 A1
(43) Pub. Date: Feb. 8, 2024

(54) ELECTRONIC DEVICE, CHARGER, AND CONTROL METHOD AND CONTROL APPARATUS THEREFOR

(71) Applicant: VIVO MOBILE COMMUNICATION CO., LTD., Dongguan (CN)

(72) Inventor: Zhiwen WU, Dongguan (CN)

(73) Assignee: VIVO MOBILE COMMUNICATION CO., LTD., Dongguan (CN)

(21) Appl. No.: 18/381,610

(22) Filed: Oct. 18, 2023

Related U.S. Application Data
(63) Continuation of application No. PCT/CN2022/087142, filed on Apr. 15, 2022.

(30) Foreign Application Priority Data
Apr. 19, 2021 (CN) 202110419214.2

(51) Int. Cl. H02J 50/10; H02J 50/00; H02J 50/90; H02J 50/80

(52) U.S. Cl. CPC H02J 50/10; H02J 50/005; H02J 50/90; H02J 50/80

(57) ABSTRACT

An electronic device, and a control method are provided. The electronic device includes: a first magnetic member and a first control member. The first magnetic member includes a first magnetic portion and a second magnetic portion. The first magnetic portion is different from the second magnetic portion. The first control member is configured to control the first magnetic member to switch between a first state and a second state. When the first magnetic member is in the first state, the first magnetic member and a second magnetic member of a charger are attracted to each other. When the first magnetic member is in the second state, the first magnetic member and the second magnetic member are separated from each other.

### CROSS-REFERENCE TO RELATED APPLICATIONS

This application is a continuation of International Application No. PCT/CN2022/087142, filed on Apr. 15, 2022, which claims priority to Chinese Patent Application No. 202110419214.2, filed on Apr. 19, 2021. The entire contents of each of the above-referenced applications are expressly incorporated herein by reference.

### TECHNICAL FIELD

This application pertains to the technical field of charging control of electronic device, and specifically relates to an electronic device, a charger, and a control method and a control apparatus therefor.

### BACKGROUND

With the development of science and technology, electronic devices such as mobile phones, wearable devices, and laptops have been more and more widely used. A wireless charging technology and apparatus can improve user experience of such electronic device during charging. and therefore are widely welcomed by users.

The wireless charging apparatus generally implements charging through magnetic induction. For example, a charger is provided with a transmitting charging coil, and a charged electronic device is provided with a receiving charging coil. The transmitting charging coil and the receiving charging coil are coupled to each other for mutual inductance to implement wireless charging. In a charging state, the transmitting charging coil and the receiving charging coil need to be aligned with each other, to ensure efficiency and effect of charging of the electronic device.

In the related art, to ensure that the transmitting charging coil and the receiving charging coil can be aligned with each other, a magnetic component with opposite magnetic poles usually needs to be disposed on the charger and the electronic device, to align the transmitting charging coil and the receiving charging coil with each other by using a characteristic of mutual attraction of the opposite magnetic poles.

One of disadvantages of the related art is that, although the magnetic component can implement easy and accurate alignment between the transmitting charging coil and the receiving charging coil, the electronic device and the charger always are attracted to each other. After the charging is completed or the user needs to temporarily use the electronic device, the user needs to manually separate the electronic device from the charger, resulting in unsatisfactory convenience for the user's operation. In addition, when the user needs to suddenly or rapidly separate the electronic device from the charger in an emergency (for example, in a case that the electronic device has an incoming call during charging), the electronic device and the charger that are attracted to each other are prone to falling or bumping due to sudden pulling.

### SUMMARY

This application aims to provide an electronic device, a charger, and a control method and a control apparatus therefor.

This application is implemented as follows:

According to a first aspect, an embodiment of this application provides an electronic device, including: a first magnetic member, where the first magnetic member includes a first magnetic portion and a second magnetic portion, and the first magnetic portion is different from the second magnetic portion; and a first control member, where the first control member is configured to control the first magnetic member to switch between a first state and a second state; and in a case that the first magnetic member is in the first state, the first magnetic member and a second magnetic member of a charger are attracted to each other, and in a case that the first magnetic member is in the second state, the first magnetic member and the second magnetic member are separated from each other.

According to a second aspect, an embodiment of this application provides a charger, including: a second magnetic member, where the second magnetic member includes a third magnetic portion and a fourth magnetic portion, and the third magnetic portion is different from the fourth magnetic portion; and a second control member, where the second control member is configured to control the second magnetic member to switch between a third state and a fourth state; and in a case that the second magnetic member is in the third state, the second magnetic member and a first magnetic member of an electronic device are attracted to each other, and in a case that the second magnetic member is in the fourth state, the second magnetic member and the first magnetic member are separated from each other.

According to a third aspect, an embodiment of this application provides a control method for an electronic device, performed to control the electronic device in the first aspect of this application, where the control method includes: obtaining a target state of the electronic device; and controlling, by using a first control member in a case that the target state meets a preset condition, a first magnetic member to switch from a first state to a second state.

According to a fourth aspect, an embodiment of this application provides a control method for a charger, performed to control the charger in the second aspect of this application, where the control method includes: obtaining a target state of an electronic device that cooperates with the charger, and controlling, by using a second control member in a case that the target state meets a preset condition, a second magnetic member to switch from a third state to a fourth state.

According to a fifth aspect, an embodiment of this application provides a control apparatus for an electronic device, configured to control the electronic device in the first aspect of this application, where the control apparatus includes: a first obtaining module, where the first obtaining module is configured to obtain a target state of the electronic device; and a first processing module, where the first processing module is configured to: in a case that the target state obtained by the first obtaining module meets a preset condition, control, by using a first control member, a first magnetic member to switch from a first state to a second state.

According to a sixth aspect, an embodiment of this application provides a control apparatus for a charger, configured to control the charger in the second aspect of this application, where the control apparatus includes: a second obtaining module, where the second obtaining module is configured to obtain a target state of an electronic device that cooperates with the charger; and a second processing module, where the second processing module is configured to: in a case that the target state obtained by the second obtaining module meets a preset condition, control, by using a second control member, a second magnetic member to switch from a third state to a fourth state.

According to a seventh aspect, an embodiment of this application provides an electronic device, including a processor, a memory, and a program or an instruction that is stored in a memory and that can be run on the processor, where the program or the instruction is executed by the processor to implement the steps of the control method in the third aspect of this application, or the steps of the control method in the fourth aspect of this application.

According to an eighth aspect, an embodiment of this application provides a readable storage medium, where a program or an instruction is stored on the readable storage medium, and the program or the instruction is executed by a processor to implement the steps of the control method in the third aspect of this application, or the steps of the control method in the fourth aspect of this application.

### BRIEF DESCRIPTION OF DRAWINGS

The foregoing and/or additional aspects and advantages of this application will become apparent and readily understood from the descriptions of the embodiments with reference to the following accompanying drawings, in which:

FIG. 1 is a first schematic diagram of a manner in which an electronic device in a first state cooperates with a charger according to an embodiment of this application;

FIG. 2 is a first schematic diagram of a manner in which an electronic device in a second state cooperates with a charger according to an embodiment of this application;

FIG. 3 is a second schematic diagram of a manner in which an electronic device in a first state cooperates with a charger according to an embodiment of this application;

FIG. 4 is a second schematic diagram of a manner in which an electronic device in a second state cooperates with a charger according to an embodiment of this application;

FIG. 5 is a first schematic diagram of a manner in which an electronic device in a third state cooperates with a charger according to an embodiment of this application;

FIG. 6 is a first schematic diagram of a manner in which an electronic device in a fourth state cooperates with a charger according to an embodiment of this application;

FIG. 7 is a second schematic diagram of a manner in which an electronic device in a third state cooperates with a charger according to an embodiment of this application;

FIG. 8 is a second schematic diagram of a manner in which an electronic device in a fourth state cooperates with a charger according to an embodiment of this application

FIG. 9 is a flowchart of steps of a control method for an electronic device according to an embodiment of this application;

FIG. 10 is a schematic diagram of a display interface of an electronic device according to an embodiment of this application;

FIG. 11 is a flowchart of steps of a control method for a charger according to an embodiment of this application;

FIG. 12 is a flowchart of steps of a control method for a terminal according to an embodiment of this application;

FIG. 13 is a schematic composition diagram of a control apparatus for an electronic device according to an embodiment of this application;

FIG. 14 is a schematic composition diagram of a control apparatus for a charger according to an embodiment of this application; and

FIG. 15 is a schematic composition diagram of an electronic device according to an embodiment of this application.

### DETAILED DESCRIPTION

The following describes in detail the embodiments of this application, and the examples of the embodiments are shown in the accompanying drawings. Identical or similar reference numerals represent identical or similar elements or elements having identical or similar functions. The embodiments described below with reference to the accompanying drawings are exemplary and are intended to explain this application without being construed as limiting this application. All other embodiments obtained by a person of ordinary skill in the art based on the embodiments of this application without creative efforts shall fall within the protection scope of this application.

In the specification and claims of this application, features of terms “first” and “second” may explicitly or implicitly include one or more features. In descriptions of this application, unless otherwise stated, “multiple” means “at least two”. In addition, in the specification and the claims, “and/or” represents at least one of connected objects, and a character “/” generally represents an “or” relationship between associated objects.

In the description of this application, it should be understood that directions or position relationships indicated by terms “clockwise”, “counterclockwise”, “circumferential”, and the like are based on directions or position relationships shown by the accompanying drawings, which are used only for describing this application and for description simplicity, but do not indicate or imply that an indicated apparatus or component must have a specific orientation or must be constructed and operated in a specific orientation. Therefore, this cannot be understood as a limitation on this application.

In the descriptions of this application, it should be noted that terms “installation” “joint”, and “connection” should be understood in a broad sense unless there is a specific stipulation and limitation. For example, “connection” may be a fixed connection, a dismountable connection, or an integrated connection; may be a mechanical connection or an electrical connection; and may be a direct connection, an indirect connection through an intermediate medium, or a connection inside two components. For persons of ordinary skill in the art, specific meanings of the foregoing terms in this application may be understood based on a specific situation.

For electronic devices such as a mobile phone, a wearable device, and a notebook computer, a wireless charging technology and apparatus can improve user experience of such electronic devices during charging and have a wide application prospect. The wireless charging technology is a technology in which charging is implemented through wireless magnetic induction. To implement magnetic induction, charging coils need to be separately disposed on an electronic device and a charger adapted to the electronic device. A charging coil disposed on the electronic device is a receiving charging coil, and a charging coil disposed on the charger is a transmitting charging coil. To ensure that the receiving charging coil and the transmitting charging coil can be easily and accurately aligned with each other, the electronic device and the charger adapted to the electronic device are generally further separately provided with magnetic components. A magnetic component disposed on the electronic device surrounds a peripheral edge of the receiving charging coil, and a magnetic component disposed on the charger surrounds a peripheral edge of the transmitting charging coil. The magnetic component disposed on the electronic device and the magnetic component disposed on the charger are opposite magnetic poles and are attracted to each other, to implement positioning alignment between the receiving charging coil and the transmitting charging coil. Although alignment between the transmitting charging coil and the receiving charging coil can be implemented in the related art, when the electronic device in the related art performs wireless charging, the electronic device and the charger are always attracted to each other. Therefore, after charging is completed or when a user needs to temporarily use the electronic device, the user needs to manually separate the electronic device from the charger that adapts to the electronic device. Therefore, there is a technical problem in the related art that the wireless charging technology and apparatus are not sufficiently convenient for the user to operate. In particular, when the user needs to suddenly or rapidly separate the electronic device from the charger in an emergency (for example, in a case that the electronic device has an incoming call during charging), the wireless charging technology and apparatus in the related art are prone to a disadvantage in which the electronic device and the charger that are attracted to each other have falling or bumping due to sudden pulling.

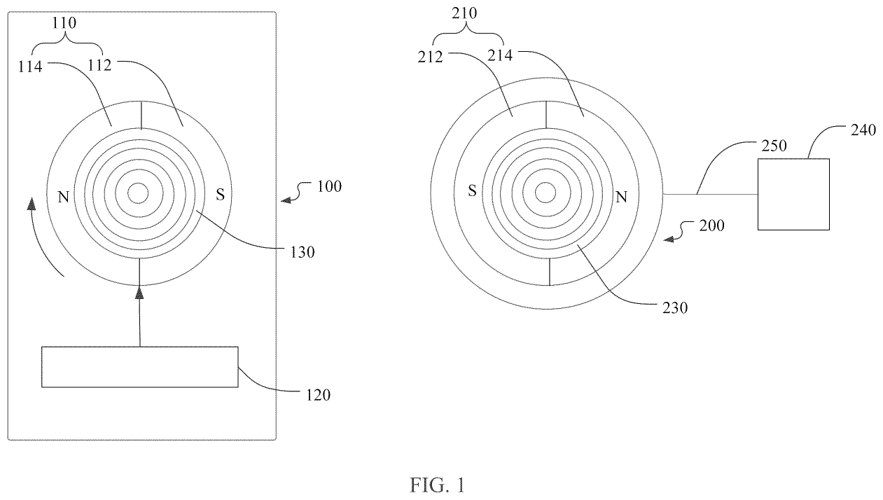

The following describes an electronic device, a charger, a control method and a control apparatus therefor according to the embodiments of this application with reference to FIG. 1 to FIG. 15.

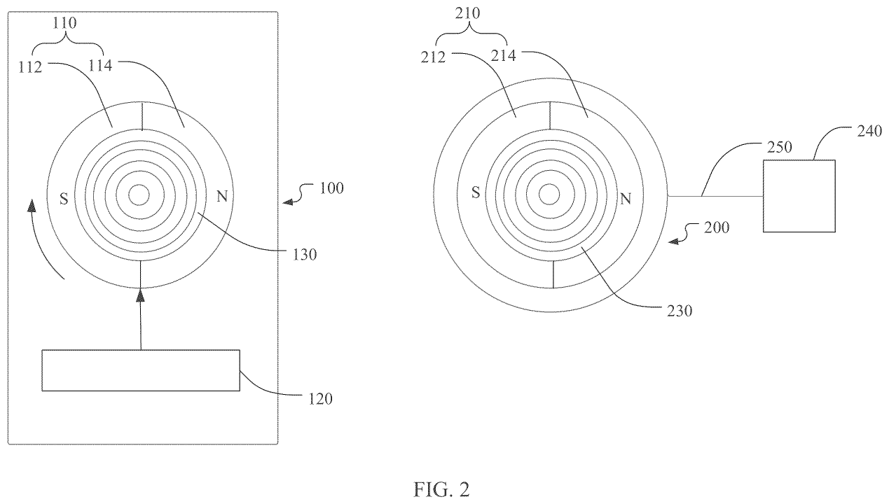

As shown in FIG. 1 and FIG. 2, an embodiment of this application provides an electronic device 100, including a first magnetic member 110 and a first control member 120. The first magnetic member 110 includes a first magnetic portion 112 and a second magnetic portion 114, and the first magnetic portion 112 is different from the second magnetic portion 114. The first control member 120 is configured to control the first magnetic member 110 to switch between a first state and a second state. In a case that the first magnetic member 110 is in the first state, the first magnetic member 110 and a second magnetic member 210 of a charger 200 are attracted to each other, and in a case that the first magnetic member 110 is in the second state, the first magnetic member 110 and the second magnetic member 210 are separated from each other.

The electronic device 100 in this embodiment of this application may be a device such as a mobile phone, a tablet computer, a notebook computer, a palmtop computer, an in-vehicle electronic device, a wearable device, an Ultra-Mobile Personal Computer (UMPC), a netbook, or a Personal Digital Assistant (PDA), or the electronic device may be another type of electronic device. This is not limited in this embodiment of this application.

The first magnetic member 110 in this embodiment of this application may be made of a ferromagnetic metal material such as iron, cobalt, or nickel, and may be a permanent magnet magnetic member or an electronic control magnetic member. This may be determined according to an actual use requirement, and is not limited in this embodiment of this application.

A shape of the first magnetic member 110 in this embodiment of this application may be any one of a ring, a sector, a circle, and a polygon. This may be determined according to an actual use requirement, and is not limited in this embodiment of this application.

The first magnetic member 110 in this embodiment of this application may be disposed on a back or a bottom of the electronic device 100. This may be determined according to an actual use requirement, and is not limited in this embodiment of this application.

There may be one or more first magnetic members 110 in this embodiment of this application. This may be determined according to an actual use requirement, and is not limited in this embodiment of this application.

For example, if the electronic device 100 is a mobile phone or a netbook, because a size of such electronic device 100 is large, and a shape of such electronic device 100 is flat, there may be a plurality of first magnetic members 110 of such electronic device 100, and the plurality of first magnetic members 110 may be distributed on a backplane of the electronic device 100.

For another example, if the electronic device 100 is a wearable device such as an electric toothbrush or a smart band, or a smart watch, because a size of such electronic device 100 is small, and a shape of such electronic device 100 is more three-dimensional than a mobile phone or a netbook, there may be one first magnetic member 110 of such electronic device 100. A shape of the first magnetic member 110 may be a ring and disposed in a circumferential direction around a first charging coil 130 of the electronic device 100 at the bottom of the electronic device 100.

The first control member 120 in this embodiment of this application may be a motor, an electronic control switch, or a magnetron switch. This may be determined according to an actual use requirement, and is not limited in this embodiment of this application.

The electronic device 100 in this embodiment of this application is adapted to the charger 200, and the charger 200 is configured to perform wireless charging on the electronic device 100. The first magnetic member 110 is configured to implement positioning alignment between the electronic device 100 and the charger 200 that is adapted to the electronic device 100.

To implement the foregoing function, the first magnetic member 110 and the second magnetic member 210 of the charger 200 are opposite in location and set as magnetic poles in different names. The first magnetic member 110 includes the first magnetic portion 112 and the second magnetic portion 114, and the first magnetic portion 112 is different from the second magnetic portion 114. The second magnetic member 210 includes a third magnetic portion 212 and a fourth magnetic portion 214, and the third magnetic portion 212 is different from the fourth magnetic portion 214. The first magnetic portion 112 and the third magnetic portion 212 are opposite in location and set as magnetic poles in different names, and the second magnetic portion 114 and the fourth magnetic portion 214 are opposite in location and set as magnetic poles in different names. When the first magnetic member 110 and the second magnetic member 210 are close to each other, the first magnetic member 110 and the second magnetic member 210 are attracted to each other and are in contact, thereby implementing alignment between the first charging coil 130 (that is, a receiving charging coil) of the electronic device 100 and a second charging coil 230 (that is, a transmitting charging coil) of the charger 200.

The first control member 120 is electrically connected to the first magnetic member 110 or is connected to the first magnetic member 110 by using a power drive member. The first control member 120 is configured to control the first magnetic member 110 to move, magnetize, or demagnetize, so that the first magnetic member 110 switches from the first state (that is, a state of being attracted to the second magnetic member 210) to the second state (that is, a state of being separated from the second magnetic member 210).

It can be understood that the first control member 120 can not only be configured to control the first magnetic member 110 to switch from the first state to the second state, but also can be configured to control the first magnetic member 110 to switch from the second state to the first state.

It can be understood that mutual separation in this embodiment of this application may be attraction cancellation between the first magnetic member 110 and the second magnetic member 210, or may be mutual repelling between the first magnetic member 110 and the second magnetic member 210.

It can be understood that, in a case that the first magnetic member 110 in the second state and the second magnetic member 210 repel each other, a person skilled in the art may control, according to an actual requirement, a repelling force between the first magnetic member 110 and the second magnetic member 210 by adjusting materials, sizes, quantities, and disposing locations of the first magnetic member 110 and the second magnetic member 210.

For example, if the electronic device 100 is a tablet computer with a large weight, a size of the first magnetic member 110 and a size of the second magnetic member 210 may be increased or a quantity of the first magnetic member 110 and a quantity of the second magnetic member 210 may be increased, to ensure that the electronic device 100 is tightly connected and fastened to the charger 200 in a wireless charging state, and ensure that a user can easily separate the electronic device 100 from the charger 200 when the electronic device 100 is in a non-charging state or when the user may need to access the electronic device 100.

For another example, if the electronic device 100 is a smart band or a Bluetooth headset with a small weight, a size of the first magnetic member 110 and a size of the second magnetic member 210 may be reduced or a quantity of the first magnetic member 110 and a quantity of the second magnetic member 210 may be reduced, so that on the basis of ensuring that the electronic device 100 is tightly connected and fastened to the charger 200 in a wireless charging state, the electronic device 100 is prevented from being bounced off due to a repelling force between opposite magnetic poles when the electronic device 100 is in a non-charging state or when the user may need to access the electronic device 100.

In a case that the first magnetic portion 112 is a south magnetic pole, the second magnetic portion 114 is a north magnetic pole; or in a case that the first magnetic portion 112 is in a magnetized state, the second magnetic portion 114 is in a demagnetized state.

For example, the first magnetic member 110 is a South magnetic pole (S pole), and the second magnetic member 210 is a North magnetic pole (N pole) corresponding to the south pole of the first magnetic member 110.

For another example, the first magnetic member 110 includes one or more south poles and one or more north poles disposed side by side, and the second magnetic member 210 also includes one or more north poles and one or more south poles disposed side by side. A disposing location of the south pole in the first magnetic member 110 corresponds to a disposing location of the north pole in the second magnetic member 210, and a disposing location of the north pole in the first magnetic member 110 corresponds to a disposing location of the south pole in the second magnetic member 210.

For example, in this embodiment of this application, the first magnetic portion 112 and the second magnetic portion 114 may be arranged in an annular manner.

For example, in this embodiment of this application, there may be may be one or more first magnetic portions 112 and one or more second magnetic portions 114.

For example, in this embodiment of this application, the first magnetic portion 112 and the second magnetic portion 114 may be continuously arranged or arranged apart.

It can be understood that the first control member 120 in this embodiment of this application may control the first magnetic member 110 through circuit on-off or mechanical driving.

For example, the first control member 120 controls the first magnetic member 110 to demagnetize, so that the first magnetic member 110 switches from the first state to the second state, and controls the first magnetic member 110 to magnetize, so that the first magnetic member 110 switches from the second state to the first state.

For another example, the first control member 120 controls the first magnetic member 110 to shift, so that the first magnetic member 110 switches from the first state to the second state, and controls the first magnetic member 110 to reset, so that the first magnetic member 110 switches from the second state to the first state.

Because the first control member 120 can control the first magnetic member 110 to switch from the state of being attracted to the second magnetic member 210 to the state of being separated from the second magnetic member 210, the electronic device 100 provided in this embodiment of this application can release a magnetic relationship between the electronic device 100 and the charger 200 after charging is completed or when the user needs to temporarily use the electronic device, thereby improving convenience for the user's operation. In addition, when the user needs to suddenly or rapidly separate the electronic device 100 from the charger 200 in an emergency, the electronic device 100 provided in this embodiment of this application can avoid a drawback of falling or bumping of the electronic device 100 and the charger 200 that are attracted to each other due to sudden pulling.

For example, in this embodiment of this application, the first control member 120 is configured to drive the first magnetic member 110 to rotate or flip, to control the first magnetic member 110 to switch from the first state to the second state.

In some embodiments, the first control member 120 may be a motor. The first control member 120 is connected to the first magnetic member 110 by using, for example, a drive member of a gear or a connecting rod. The first magnetic member 110 may have a circular disk shape or a circular ring shape. The first control member 120 drives the first magnetic member 110 to perform a rotation action or a flip action, so that the first magnetic member 110 rotates along a plane in which the first magnetic member 110 is located, or the first magnetic member 110 flips along a plane in which the first magnetic member 110 is located. Therefore, the first magnetic member 110 that originally corresponds to the second magnetic member 210 in location and that is mutually attracted may be separated from the second magnetic member 210, so that the electronic device 100 and the charger 200 can be conveniently and easily separated from each other.

For example, in this embodiment of this application, the first magnetic member 110 is an electronic control magnetic member, and the first control member 120 is configured to control the first magnetic member 110 to magnetize or demagnetize, to control the first magnetic member 110 to switch from the first state to the second state.

In some embodiments, the first control member 120 may be an electronic control switch. The first control member 120 is electrically connected to the first magnetic member 110 through a wired connection or a wireless connection. The first magnetic member 110 may be an electronic control permanent magnet. The first control member 120 controls the first magnetic member 110 to magnetize, to make the first magnetic member 110 magnetic or change magnetic circuit distribution of the first magnetic member 110, so that the first magnetic member 110 and the second magnetic member 210 are attracted to each other. The first control member 120 controls the first magnetic member 110 to demagnetize or controls the first magnetic member 110 to change magnetic circuit distribution again, so that the first magnetic member 110 and the second magnetic member 210 are separated from each other.

For example, in this embodiment of this application, as shown in FIG. 1 and FIG. 2, the first magnetic member 110 includes at least one first magnetic portion 112 and at least one second magnetic portion 114, and a first driving member 120 is configured to drive the at least one first magnetic portion 112 and the at least one second magnetic portion 114 to be interchanged, to control the first magnetic member 110 to switch from the first state to the second state.

For example, in this embodiment of this application, there may be one or more first magnetic portions 112 and one or more second magnetic portions 114. A quantity of first magnetic portions 112 and a quantity of second magnetic portions 114 may be equal or not equal. The first magnetic portion 112 and the second magnetic portion 114 may be continuously disposed, or may be spaced apart from each other by another non-magnetic member (for example, a separator or a connector). This may be determined according to an actual use requirement, and is not limited in this embodiment of this application.

For example, as shown in FIG. 1, the first magnetic member 110 includes one first magnetic portion 112 (that is, a south magnetic pole S of the electronic device 100 in FIG. 1) and one second magnetic portion 114 (that is, a north magnetic pole N of the electronic device 100 in FIG. 1) that each have a semi-circular ring shape. The one first magnetic portion 112 and the one second magnetic portion 114 are symmetrically arranged around the first charging coil 130, and a circular ring structure is defined by splicing. The first control member 120 is a motor, and is directly connected to the first magnetic member 110 or indirectly connected to the first magnetic member 110 by using a gear member, so that the first control member 120 can drive the first magnetic member 110 to rotate. The second magnetic member 210 includes one third magnetic portion 212 and one fourth magnetic portion 214 that each have a semi-circular ring shape. The one third magnetic portion 212 and the one fourth magnetic portion 214 are symmetrically arranged around the second charging coil 230, and a circular ring structure is formed by splicing. The second charging coil 230 is connected to an adapter 240 by using a cable 250, and the adapter 240 may be connected to a power supply on the wall. When the first magnetic member 110 is in the first state, the first magnetic portion 112 and the fourth magnetic portion 214 are opposite in location and are attracted and engaged with each other, and the second magnetic portion 114 and the third magnetic portion 212 are opposite in location and are attracted and engaged with each other. In this way, the electronic device 100 and the charger 200 are attracted to each other, and positioning alignment between the first charging coil 130 of the electronic device 100 and the second charging coil 230 of the charger 200 is implemented. The first control member 120 may drive the first magnetic member 110 to rotate 180° along the plane in which the first magnetic member 110 is located, so that the first magnetic member 110 switches from the first state to the second state. As shown in FIG. 2, when the first magnetic member 110 is in the second state, the first magnetic portion 112 and the third magnetic portion 212 are opposite in location and are mutually repelled and separated from each other, and the second magnetic portion 114 and the fourth magnetic portion 214 are opposite in location and mutually repelled and separated from each other. In this way, the electronic device 100 and the charger 200 are separated from each other, so that the user can access the electronic device 100. It can be understood that, to implement mutual attraction between the electronic device 100 and the charger 200 again during charging, the first control member 120 may be reversed by using the motor, so that the first magnetic member 110 switches from the second state to the first state.

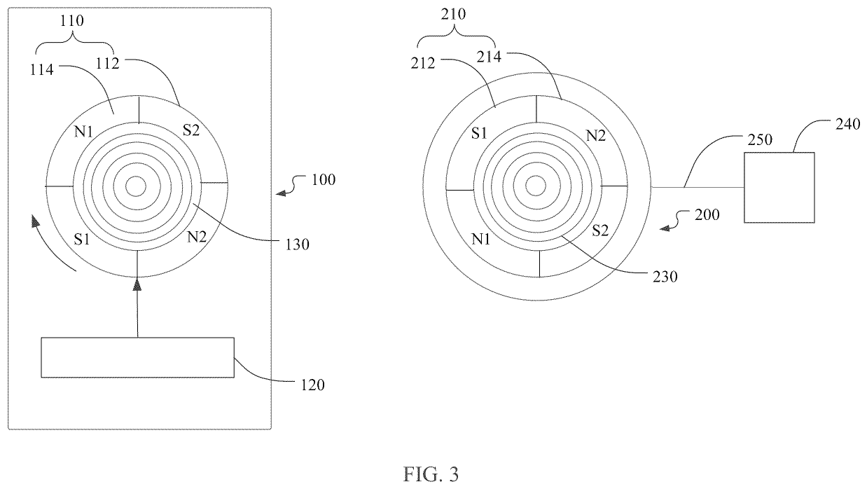

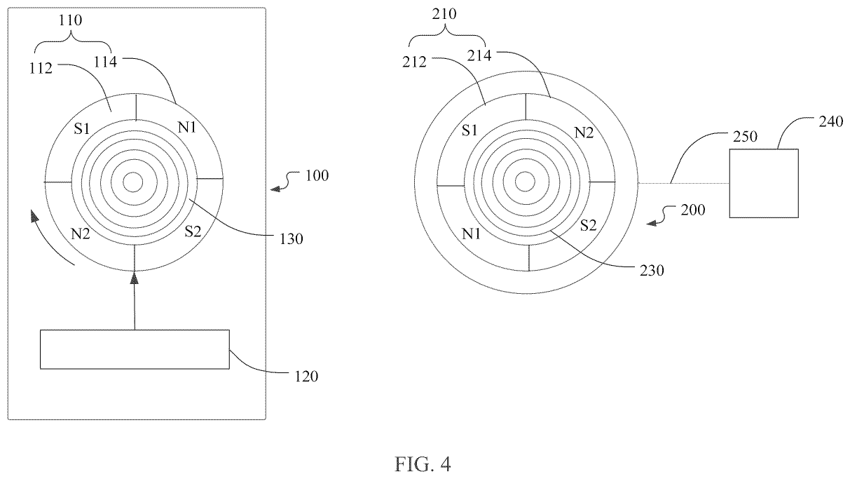

For another example, as shown in FIG. 3, the first magnetic member 110 includes two first magnetic portions 112 (that is, a south magnetic pole S1 and a south magnetic pole S2 of the electronic device 100 in FIG. 1) and two second magnetic portions 114 (that is, a north magnetic pole N1 and a north magnetic pole N2 of the electronic device 100 in FIG. 1) that each have a quarter of a circular ring shape. The two first magnetic portions 112 and the two second magnetic portions 114 are symmetrically arranged apart around south and north magnetic poles of the first charging coil 130, and a circular ring structure is defined by splicing. The first control member 120 is a motor, and is directly connected to the first magnetic member 110 or indirectly connected to the first magnetic member 110 by using a gear member, so that the first control member 120 can drive the first magnetic member 110 to rotate. The second magnetic member 210 includes two third magnetic portions 212 and two fourth magnetic portions 214 that each have a quarter of a circular ring shape. The two third magnetic portions 212 and the two fourth magnetic portions 214 are symmetrically arranged apart around south and north magnetic poles of the second charging coil 230, and a circular ring structure is defined by splicing. The second charging coil 230 is connected to an adapter 240 by using a cable 250, and the adapter 240 may be connected to a power supply on the wall. When the first magnetic member 110 is in the first state, the two first magnetic portions 112 and the two fourth magnetic portions 214 are opposite in location and are attracted and engaged with each other, and the two second magnetic portions 114 and the two third magnetic portions 212 are opposite in location and are attracted and engaged with each other. In this way, the electronic device 100 and the charger 200 are attracted to each other, and positioning alignment between the first charging coil 130 of the electronic device 100 and the second charging coil 230 of the charger 200 is implemented. The first control member 120 may drive the first magnetic member 110 to rotate 90° along the plane in which the first magnetic member 110 is located, so that the first magnetic member 110 switches from the first state to the second state. As shown in FIG. 4, when the first magnetic member 110 is in the second state, the two first magnetic portions 112 and the two third magnetic portions 212 are opposite in location and mutually repelled and separated from each other, and the two second magnetic portions 114 and the two fourth magnetic portions 214 are opposite in location and mutually repelled and separated from each other. In this way, the electronic device 100 and the charger 200 are separated from each other, so that the user can access the electronic device 100. It can be understood that, to implement mutual attraction between the electronic device 100 and the charger 200 again during charging, the first control member 120 may be reversed by using the motor, so that the first magnetic member 110 switches from the second state to the first state.

The first driving member 120 in this embodiment of this application drives the at least one first magnetic portion 112 and the at least one second magnetic portion 114 to be interchanged, to control the first magnetic member 110 to switch from the first state to the second state. A control manner thereof is simple and convenient. In addition, a repelling force between the first magnetic member 110 in the second state and the second magnetic member 210 may be produced, to further implement fast and convenient separation between the electronic device 100 and the charger 200

For example, in this embodiment of this application, as shown in FIG. 1 and FIG. 2, the electronic device 100 further includes the first charging coil 130. The first magnetic portion 112 and the second magnetic portion 114 are arranged apart around the first charging coil 130.

For example, in this embodiment of this application, a quantity of first magnetic portions 112 and a quantity of second magnetic portions 114 are respectively even numbers.

It can be understood that the first charging coil 130 in this embodiment of this application is a receiving charging coil. If the electronic device 100 is in a charging state, the first charging coil 130 and the second charging coil 230 of the charger 200 are mutually coupled and induced.

It can be understood that, the more the first magnetic portion 112 and the second magnetic portion 114 are, the more rotation angles may be selected by the first control member 120 when a control operation is performed. For example, in a case that there are two first magnetic portions 112 and two second magnetic portion 114s in FIG. 3, the first control member 120 may rotate the first magnetic member 110 by 90° or 180°, to implement state switching of the first magnetic member 110. In a case that there are three first magnetic portions 112 and three second magnetic portions 114, the first control member 120 may rotate the first magnetic member 110 by 60° or 120°, to implement state switching of the first magnetic member 110.

It can be understood that, when performing the control operation, the first control member 120 may rotate a preset angle less than 360° (for example, 30°), to implement state switching of the first magnetic member 110. When performing the control operation, the first control member 120 may rotate a preset angle greater than 360° (for example, 390° or 750°), to implement state switching of the first magnetic member 110, thereby avoiding or reducing an error caused by fast start/stop of the motor.

The quantity of first magnetic portions 112 and the quantity of second magnetic portions 114 are set to even numbers, and the first magnetic portion 112 and the second magnetic portion 114 are disposed apart around the first charging coil 130, thereby further ensuring accurate alignment and efficient coupling and mutual inductance between the first charging coil 130 and the second charging coil 230, to ensure charging efficiency and effect.

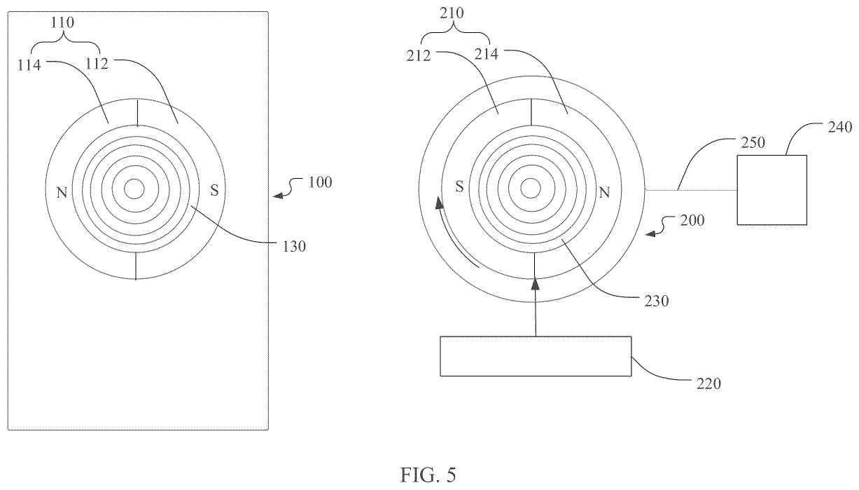

As shown in FIG. 5 and FIG. 6, an embodiment of this application provides a charger 200, including a second magnetic member 210 and a second control member 220. The second magnetic member 210 includes a third magnetic portion 212 and a fourth magnetic portion 214, and the third magnetic portion 212 is different from the fourth magnetic portion 214. The second control member 220 is configured to control the second magnetic member 210 to switch between a third state and a fourth state. In a case that the second magnetic member 210 is in the third state, the second magnetic member 210 and a first magnetic member 110 of an electronic device 100 are attracted to each other, and in a case that the second magnetic member 210 is in the fourth state, the second magnetic member 210 and the first magnetic member 110 are separated from each other.

The charger 200 in this embodiment of this application may be a charging plug that can be electrically connected to a power supply on the wall, or may be a power storage apparatus such as a mobile power supply. This may be determined according to an actual use requirement, and is not limited in this embodiment of this application.

Referring to the foregoing descriptions of the first magnetic member 110 in this embodiment of this application, a material, a shape, a disposing location, and a quantity of the second magnetic member 210 in this embodiment of this application may be determined according to an actual use requirement, and is not limited in this embodiment of this application.

For example, if the charger 200 is a charging socket, because a size of such charger 200 may be designed to be large, there may be a plurality of second magnetic members 210 of such charger 200, and the plurality of second magnetic members 210 may be distributed on a surface of the charger 200.

For another example, if the charger 200 is a mobile power supply, because a size of such charger 200 is small and high portability is required, there may be one second magnetic member 210 of the charger 200.

Referring to the foregoing descriptions of the first control member 120 in this embodiment of this application, the second control member 220 in this embodiment of this application may be a motor, an electronic control switch, or a magnetron switch. This may be determined according to an actual use requirement, and is not limited in this embodiment of this application.

The charger 200 in this embodiment of this application is adapted to the electronic device 100, and the charger 200 is configured to perform wireless charging on the electronic device 100. The second magnetic member 210 is configured to implement positioning alignment between the charger 200 and the electronic device 100 adapted to the charger 200. A manner of implementing mutual attraction between the first magnetic member 110 and the second magnetic member 210 and a manner of implementing mutual alignment between the first charging coil 130 of the electronic device 100 and the second charging coil 230 of the charger 200 are the same as those of the above. Details are not described herein again.

The second control member 220 is electrically connected to the second magnetic member 210 or is connected to the second magnetic member 210 by using a mechanical member through power driving. The second control member 220 is configured to control the second magnetic member 210 to move, magnetize, or demagnetize, so that the second magnetic member 210 switches from the third state (that is, a state of being attracted to the first magnetic member 110) to the fourth state (that is, a state of being separated from the first magnetic member 110).

It can be understood that the second control member 220 can not only be configured to control the second magnetic member 210 to switch from the third state to the fourth state, but also can be configured to control the second magnetic member 210 to switch from the fourth state to the third state.

It can be understood that mutual separation in this embodiment of this application may be attraction cancellation between the second magnetic member 210 and the first magnetic member 110, or may be mutual repelling between the second magnetic member 210 and the first magnetic member 110.

It can be understood that a person skilled in the art may control, according to an actual requirement, a repelling force between the first magnetic member 110 and the second magnetic member 210 by adjusting materials, sizes, quantities, and disposing locations of the first magnetic member 110 and the second magnetic member 210. A specific adjustment manner is not described herein again.

For example, in this embodiment of this application, in a case that the third magnetic portion 212 is a south magnetic pole, the fourth magnetic portion 214 is a north magnetic pole; or in a case that the third magnetic portion 212 is in a magnetized state, the fourth magnetic portion 214 is in a demagnetized state.

For example, in this embodiment of this application, the third magnetic portion 212 and the fourth magnetic portion 214 may be arranged in an annular manner.

For example, in this embodiment of this application, there may be may be one or more third magnetic portions 212 and one or more fourth magnetic portions 214.

For example, in this embodiment of this application, the third magnetic portion 212 and the fourth magnetic portion 214 may be continuously arranged or arranged apart.

It can be understood that the second control member 220 in this embodiment of this application may control the second magnetic member 210 through circuit on-off or mechanical driving. A specific implementation thereof is the same as that of the above. Details are not described herein again.

Because the second control member 220 can control a state between the second magnetic member 210 and the first magnetic member 110 from attracting each other to being separated from each other, the electronic device 100 provided in this embodiment of this application can release a magnetic relationship between the electronic device 100 and the charger 200 after charging is completed or when the user needs to temporarily use the electronic device, thereby improving convenience for the user's operation. In addition, when the user needs to suddenly or rapidly separate the electronic device 100 from the charger 200 in an emergency, the charger 200 provided in this embodiment of this application can avoid a drawback of falling or bumping of the electronic device 100 and the charger 200 that are attracted to each other due to sudden pulling.

In addition, in this embodiment of this application, a member, namely, the second control member 220, that controls the electronic device 100 and the charger 200 to be separated from each other is disposed on the charger 200, to avoid increasing a weight and a volume of the electronic device 100, thereby ensuring portability performance of the electronic device 100 and improving user experience when the user uses the electronic device 100.

For example, in this embodiment of this application, the second control member 220 is configured to drive the second magnetic member 210 to rotate or flip, to control the second magnetic member 210 to switch from the third state to the fourth state.

A manner in which the second control member 220 drives the second magnetic member 210 to rotate or flip and an advantage may be the same as the manner in which the first control member 120 drives the first magnetic member 110 to rotate or flip. Details are not described herein again. For example, in this embodiment of this application, the second magnetic member 210 is an electronic control magnetic member, and the second control member 220 is configured to control the second magnetic member 210 to magnetize or demagnetize, to control the second magnetic member 210 to switch from the third state to the fourth state

A manner in which the second control member 220 controls the second magnetic member 210 to magnetize or demagnetize and an advantage may be the same as the manner in which the first control member 120 controls the first magnetic member 110 to magnetize or demagnetize. Details are not described herein again.

For example, in this embodiment of this application, as shown in FIG. S and FIG. 6, the second magnetic member 210 includes at least one third magnetic portion 212 and at least one fourth magnetic portion 214, and the second control member 220 is configured to drive the at least one third magnetic portion 212 and the at least one fourth magnetic portion 214 to be interchanged. to control the second magnetic member 210 to switch from the third state to the fourth state.

For example, in this embodiment of this application, there may be one or more third magnetic portions 212 and one or more fourth magnetic portions 214. A quantity of third magnetic portions 212 and a quantity of fourth magnetic portions 214 may be equal or not equal. The third magnetic portion 212 and the fourth magnetic portion 214 may be continuously disposed, or may be spaced apart from each other by another non-magnetic member (for example, a separator or a connector). This may be determined according to an actual use requirement, and is not limited in this embodiment of this application.

For example, as shown in FIG. 5, the second magnetic member 210 includes one third magnetic portion 212 (that is, a south magnetic pole S1 of the charger 200 in FIG. 5) and one fourth magnetic portion 214 (that is, a north magnetic pole N1 of the charger 200 in FIG. 5) that each have a semi-circular ring shape. The one third magnetic portion 212 and the one fourth magnetic portion 214 are symmetrically arranged around the second charging coil 230, and a circular ring structure is defined by splicing. The second control member 220 is a motor, and is directly connected to the second magnetic member 210 or indirectly connected to the second magnetic member 210 by using a gear member, so that the second control member 220 can drive the second magnetic member 210 to rotate. The second charging coil 230 is connected to an adapter 240 by using a cable 250, and the adapter 240 may be connected to a power supply on the wall. The first magnetic member 110 includes one first magnetic portion 112 and one second magnetic portion 114 that each have a semi-circular ring shape. The one first magnetic portion 112 and the one second magnetic portion 114 are symmetrically arranged around the first charging coil 130, and a circular ring structure is defined by splicing. When the second magnetic member 210 is in the third state, the third magnetic portion 212 and the second magnetic portion 114 are opposite in location and are attracted and engaged with each other, and the fourth magnetic portion 214 and the first magnetic portion 112 are opposite in location and are attracted and engaged with each other In this way, the electronic device 100 and the charger 200 are attracted to each other, and positioning alignment between the first charging coil 130 of the electronic device 100 and the second charging coil 230 of the charger 200 is implemented. The second control member 220 may drive the second magnetic member 210 to rotate 180° along the plane in which the second magnetic member 210 is located, so that the second magnetic member 210 switches from the third state to the fourth state. As shown in FIG. 6, when the second magnetic member 210 is in the fourth state, the third magnetic portion 212 and the first magnetic portion 112 are opposite in location and are mutually repelled and separated from each other, and the fourth magnetic portion 214 and the second magnetic portion 114 are opposite in location and are mutually repelled and separated from each other. In this way, the electronic device 100 and the charger 200 can be separated from each other, so that the user can access the electronic device 100. It can be understood that, to implement mutual attraction between the electronic device 100 and the charger 200 again during charging, the second control member 220 may be reversed by using the motor, so that the second magnetic member 210 switches from the fourth state to the third state.

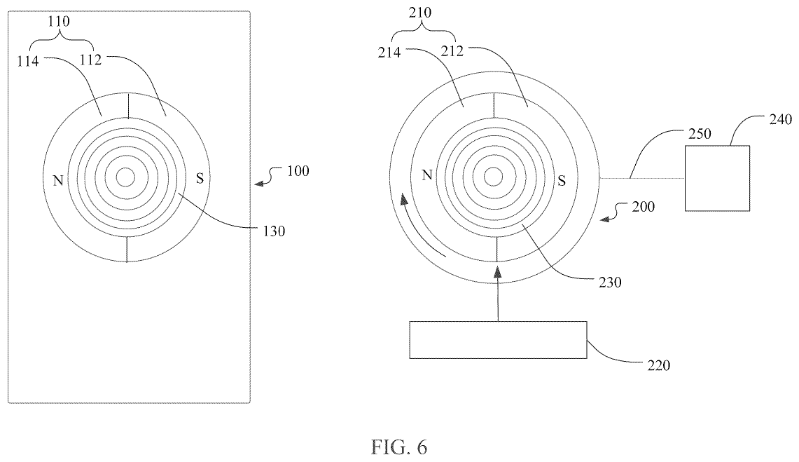

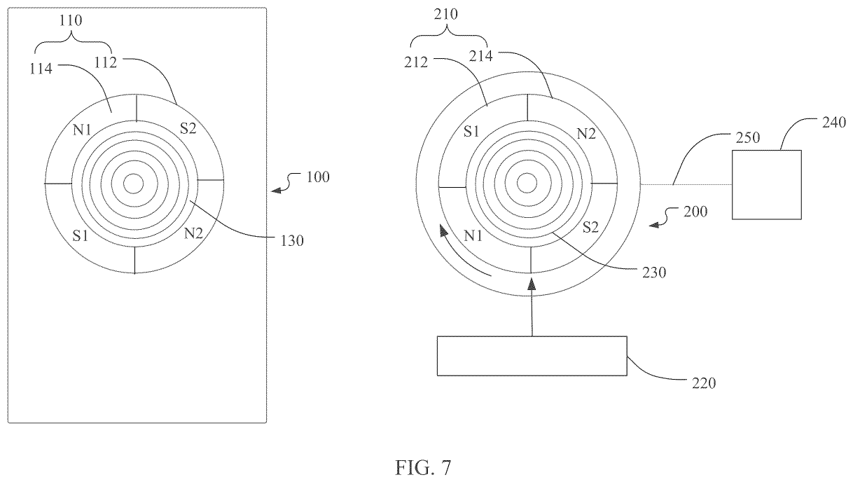

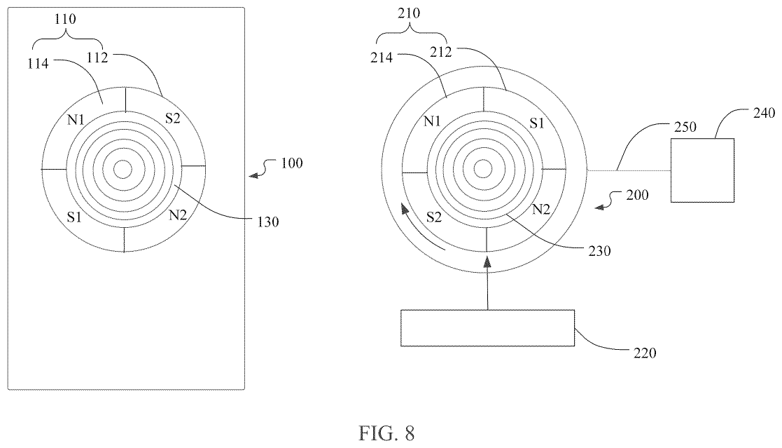

For another example, as shown in FIG. 3, the second magnetic member 210 includes two third magnetic portions 212 (that is, a south magnetic pole S1 and a south magnetic pole S2 of the charger 200 in FIG. 7) and two fourth magnetic portions 214 (that is, a north magnetic pole N1 and a north magnetic pole N2 of the charger 200 in FIG. 7) that each have a quarter of a circular ring shape. The two third magnetic portions 212 and the two fourth magnetic portions 214 are symmetrically arranged apart around south and north magnetic poles of the second charging coil 230, and a circular ring structure is defined by splicing. The second control member 220 is a motor, and is directly connected to the second magnetic member 210 or indirectly connected to the second magnetic member 210 by using a gear member, so that the second control member 220 can drive the second magnetic member 210 to rotate. The second charging coil 230 is connected to an adapter 240 by using a cable 250, and the adapter 240 may be connected to a power supply on the wall. The first magnetic member 110 includes two first magnetic portions 112 and two second magnetic portions 114 that each have a quarter of a circular ring shape. The two first magnetic portions 112 and the two second magnetic portions 114 are symmetrically arranged apart around south and north magnetic poles of the first charging coil 130, and a circular ring structure is defined by splicing. When the second magnetic member 210 is in the third state, the two third magnetic portions 212 and the two second magnetic portions 114 are opposite in location and are attracted and engaged with each other, and the two fourth magnetic portions 214 and the two first magnetic portions 112 are opposite in location and are attracted and engaged with each other. In this way, the electronic device 100 and the charger 200 are attracted to each other, and positioning alignment between the first charging coil 130 of the electronic device 100 and the second charging coil 230 of the charger 200 is implemented. The second control member 220 may drive the second magnetic member 210 to rotate 90° along the plane in which the second magnetic member 210 is located, so that the second magnetic member 210 switches from the third state to the fourth state. As shown in FIG. 8, when the second magnetic member 210 is in the fourth state, the two third magnetic portions 212 and the two first magnetic portions 112 are opposite in location and mutually repelled and separated from each other, and the two fourth magnetic portions 214 and the two second magnetic portions 114 are opposite in location and mutually repelled and separated from each other. In this way, the electronic device 100 and the charger 200 are separated from each other, so that the user can access the electronic device 100. It can be understood that, to implement mutual attraction between the electronic device 100 and the charger 200 again during charging, the second control member 220 may be reversed by using the motor, so that the second magnetic member 210 switches from the fourth state to the third state.

The second driving member 220 in this embodiment of this application drives the at least one third magnetic portion 212 and the at least one fourth magnetic portion 214 to be interchanged, to control the second magnetic member 210 to switch from the third state to the fourth state. A control manner thereof is simple and convenient. In addition, a repelling force between the second magnetic member 210 in the third state and the first magnetic member 110 may be produced, to further implement fast and convenient separation between the electronic device 100 and the charger 200.

For example, in this embodiment of this application, as shown in FIG. S and FIG. 6. the charger 200 further includes the second charging coil 230. The third magnetic portion 212 and the fourth magnetic portion 214 are arranged apart around the second charging coil 230.

For example, in this embodiment of this application, a quantity of third magnetic portions 212 and a quantity of fourth magnetic portions 214 are respectively even numbers.

It can be understood that the second charging coil 230 in this embodiment of this application is a receiving charging coil. If the charger 200 is in a charging state, the second charging coil 230 and the first charging coil 130 of the electronic device 100 are mutually coupled and induced.

It can be understood that, similarly to the above, the more the third magnetic portion 212 and the fourth magnetic portion 214 are, the more rotation angles may be selected by the second control member 220 when a control operation is performed.

It can be understood that, similarly to the above, when performing the control operation, the second control member 220 may rotate a preset angle less than 360°, or may rotate a preset angle greater than 360°.

It can be understood that, similarly to the above, the quantity of third magnetic portions 212 and the quantity of fourth magnetic portions 214 are set to even numbers, and the third magnetic portion 212 and the fourth magnetic portion 214 are disposed apart around the second charging coil 230, thereby further ensuring accurate alignment and efficient coupling and mutual inductance between the first charging coil 130 and the second charging coil 230, to ensure charging efficiency and effect.

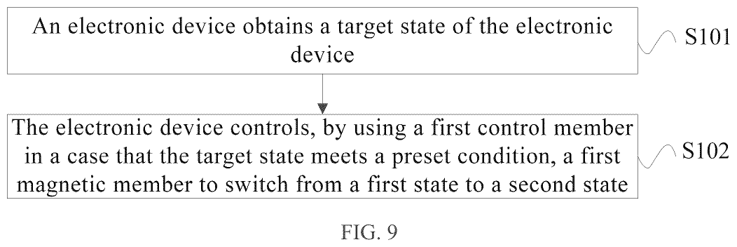

An embodiment of this application provides a control method for an electronic device, performed to control the electronic device in any one of the embodiments of this application. As shown in FIG. 9, the control method includes the following steps:

S101: An electronic device obtains a target state of the electronic device.

For example, in this embodiment of this application, the target state is used to indicate a used state of the electronic device. It can be understood that the target state may be obtained by monitoring a running state of the electronic device, for example, monitoring a battery level of the electronic device, monitoring whether the battery level of the electronic device reaches a preset battery level threshold, monitoring whether the electronic device is in a state in which an incoming call is not connected or a dialing state or a call state, monitoring whether the electronic device is being triggered, and monitoring whether an application is running in the foreground in the electronic device. The application may include a game application, a video or voice call application, and a video or music play application.

For example, in this embodiment of this application, a location state is used to indicate a physical environment in which the electronic device is placed. For example, the location state may include an off-ground height of the electronic device at the placed location, and may further include an inclination angle of the electronic device relative to a horizontal plane.

It can be understood that the location state may be obtained by detecting a physical state of the electronic device. For example, the electronic device may obtain the location state including the off-ground height and a placement angle of the electronic device by using a direction sensor and a gyroscope sensor. For another example, the electronic device may obtain the location state including a relative distance between the electronic device and an obstacle by using a proximity sensor, an infrared sensor, a millimeter wave radar, an image collection apparatus, and an image analysis technology.

S102: In a case that the target state meets a preset condition, the electronic device controls, by using a first control member, a first magnetic member to switch from a first state to a second state.

It can be understood that, in a case that the target state meets the preset condition, it may be determined that in this case, the first magnetic member may be controlled, by using the first control member, to control to switch from the first state to the second state. In other words, in this case, it is appropriate to separate the electronic device from the charger.

The target state of the electronic device is obtained, and in a case that the target state meets the preset condition, the first magnetic member is controlled, by using the first control member, to switch from the first state to the second state, thereby ensuring that a user can easily, quickly, and safely access the electronic device. The electronic device can pre-determine a trigger and use requirement of the user, so that the electronic device and the charger are separated from each other in advance.

For example, in this embodiment of this application, the target state includes at least one of the following: a battery level state, a response state, a location state, and a running state.

For example, in this embodiment of this application, S102 includes:

S102a: In a case that a battery level indicated by the battery level state is greater than a threshold, control, by using the first control member, the first magnetic member to switch from the first state to the second state.

For example, the target state includes the battery level state (that is, a battery level of the electronic device). The battery level state may be 100% (that is, fully charged) or 90% (that is, nearly fully charged). In a case that the target state meets the preset condition (that is, the battery level of the electronic device is fully charged or nearly fully charge), it may be determined that the electronic device has completed charging, or the electronic device is in a relatively high battery level state In this case, the first magnetic member may be controlled, by using the first control member, to switch from the first state to the second state, so that the user can always access the electronic device.

For example, in this embodiment of this application, S102 includes:

S102b: In a case that the response state indicates that a first input is received, control, by using the first control member, the first magnetic member to switch from the first state to the second state.

For example, the target state includes the response state (that is, whether the electronic device is a state in which an incoming call is not connected or a dialing state or a call state). In a case that the target state meets the preset condition (that is, the electronic device is in a state in which an incoming call is not connected or a dialing state or a call state), it may be determined that the user needs to access the electronic device. In this case, the first magnetic member may be controlled, by using the first control member, to switch from the first state to the second state, so that the user can always access the electronic device.

For example, in this embodiment of this application, S102 includes:

S102c: In a case that the location state indicates being in a preset safe location, control, by using the first control member, the first magnetic member to switch from the first state to the second state.

In other words, in this embodiment of this application, the location state may be detected, and it is determined whether the location state meets the preset safe location. In addition, in this embodiment of this application, only in a case that the location state meets the preset safe location, the first magnetic member is controlled, by using the first control member, to switch from the first state to the second state Therefore, in this embodiment of this application, safety of the electronic device can be further ensured, and fall damage of the electronic device can be effectively avoided.

For example, in this embodiment of this application, S102 includes:

S102d: When the running state indicates that a target application is running, control, by using the first control member, the first magnetic member to switch from the first state to the second state.

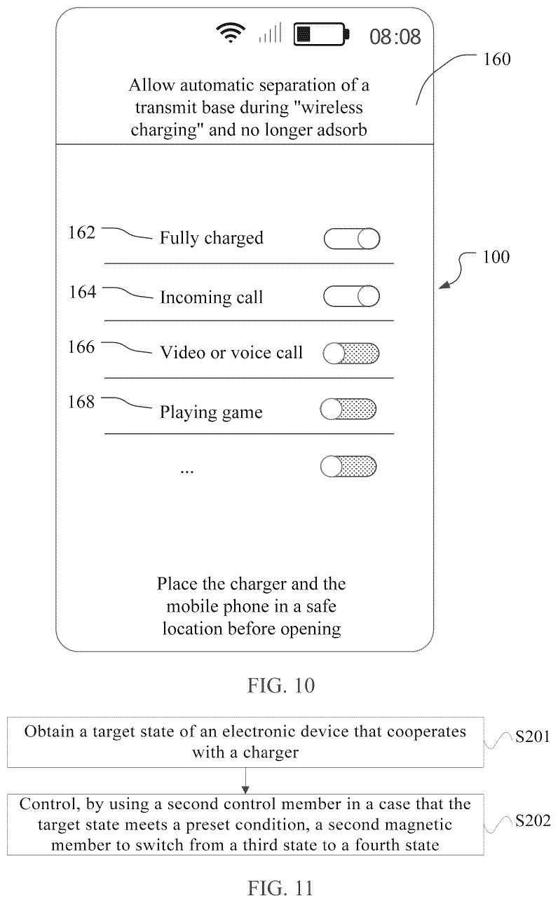

For example, in a case that the target state meets the preset condition (that is, when the user is or will or may trigger the electronic device to run a game application), it may be determined that the user needs to access the electronic device, and the first magnetic member is controlled, by using the first control member, to switch from the first state to the second state, so that the user can always access the electronic device. It can be understood that the target state may be set by the user by triggering the electronic device 100, or may be preset before delivery of the electronic device 100. For example, as shown in FIG. 10, the user may trigger a display interface 160 of the electronic device 100 to display a plurality of controls, where the plurality of controls are used to trigger enabling of the target state. The plurality of controls include a first control 162, a second control 164, a third control 166, and a fourth control 168. The first control 162 is used to trigger enabling of the battery level state as the target state, the second control 164 is used to trigger enabling of the response state as the target state, the third control 166 is used to trigger enabling of the location state as the target state, and the fourth control 168 is used to trigger enabling of the running state as the target state. When all the foregoing four controls are enabled, the electronic device may control, by using the first control member, the first magnetic member to switch from the first state to the second state in a fully charged state, a to-be-connected or connected incoming call state, a to-be-answered or answered video or voice call state, and a game program foreground running state, to separate the electronic device from the charger.

For example, in this embodiment of this application, the electronic device may perform rotation training to detect whether the first magnetic member is in the first state. In a case that the first magnetic member is in the first state, the electronic device controls, by using the first control member, the first magnetic member to switch from the first state to the second state.

It can be understood that the electronic device may detect, through rotation training in a preset period, whether the electronic device is in the first state.

It can be understood that the electronic device needs to perform S101 and S102 only in the first state, to implement separation between the electronic device and the charger.

It can be understood that, in a case that the first magnetic member is in the first state, the electronic device is generally cooperating with the charger to perform charging; or the electronic device has completed charging but has not yet been unplugged from the charger.

It can be understood that, in a case that the first magnetic member is not in the first state, the first magnetic member may be in the second state (that is, the first magnetic member and the second magnetic member repel each other or are not attracted to each other); or in this case, the electronic device is in a free state, and is not cooperating with or does not need to cooperate with the charger.

Through rotation training, it may be detected whether the first magnetic member is in the first state, so that the electronic device and the charger can be separated from each other in a timely manner when necessary or required.

For example, in this embodiment of this application, S101 includes:

S101a: Control, by using the first control member, the first magnetic member to rotate, so that the first magnetic member switches from the first state to the second state.

For example, in this embodiment of this application, S101 includes:

S101b: Control, by using the first control member, the first magnetic member to flip, so that the first magnetic member switches from the first state to the second state.

Because the first control member drives the first magnetic member to rotate or flip, to control the first magnetic member to switch from the first state to the second state, the first control member can conveniently and stably perform switching adjustment on the state of the first magnetic member. The implementation of driving flipping to control the first magnetic member to perform state switching is responsive and responsive, so that separation between the electronic device and the charger can be quickly implemented. Compared with the flipping implementation, in the implementation of driving rotation to control the first magnetic member to perform state switching, space required for performing the flipping action does not need to be reserved, and required design space is small, and therefore the rotation implementation is particularly applicable to an electronic device with a small size.

For example, in this embodiment of this application, S101 includes:

S101c: Control, by using the first control member, the first magnetic member to demagnetize, so that the first magnetic member switches from the first state to the second state.

Because the first control member controls the first magnetic member to magnetize or demagnetize, to control the first magnetic member to switch from the first state to the second state, the control manner for the first magnetic member in this embodiment of this application is simpler. In addition, the electronic control magnetic member has a small size and occupies less space.

For example, in this embodiment of this application, the S101a includes the following S101a′:

S101a′: Control, by using the first control member, the first magnetic member to rotate a first target angle, so that the first magnetic member switches from the first state to the second state

In the first state, a first magnetic portion of the first control member is in a first location, and a second magnetic portion of the first control member is in a second location. In the second state, the first magnetic portion moves to the second location by rotating the first target angle, and the second magnetic portion moves to the first location by rotating the first target angle.

It can be understood that the first magnetic member may be controlled by using the first control member to rotate the first target angle with a fixed value (for example, 30°, 60°, or 90°), so that the first magnetic member switches from the first state to the second state; or the first magnetic member may be controlled by using the first control member to rotate to a preset location, so that the first magnetic member switches from the first state to the second state.

The first control member controls the first magnetic member to rotate the first target angle, so that the first magnetic member switches from the first state to the second state. Therefore, the first control member can conveniently and stably perform switching adjustment on the state of the first magnetic member.

An embodiment of this application provides a control method for a charger, performed to control the charger in any one of the embodiments of this application. As shown in FIG. 11, the control method includes the following steps.

S201: Obtain a target state of an electronic device that cooperates with a charger.

For example, in this embodiment of this application, the target state is used to indicate that the electronic device is used to measure or indicate a used state of the electronic device.

S202: In a case that the target state meets a preset condition, control, by using a second control member, a second magnetic member to switch from a third state to a fourth state.

For example, in this embodiment of this application, a type and a monitoring manner of the target state are the same as those of the above. Details are not described herein again.

It can be understood that the target state and a result of comparing the target state with the preset condition may be directly monitored by the charger, or may be directly monitored by the electronic device, and transmitted by the electronic device to the charger through wireless transmission or wired transmission.

It can be understood that, as described above, a member (that is, the second control member) that controls the electronic device and the charger to be separated from each other is disposed on the charger, to avoid increasing a weight and a volume of the electronic device, thereby ensuring portability performance of the electronic device and improving user experience when the user uses the electronic device. Correspondingly, the charger determines whether a scene condition meets a preset scene condition, so that the charger can directly and quickly control the second control member.

For example, in this embodiment of this application, the target state includes at least one of the following. a battery level state, a response state, a location state, and a running state.

For example, in this embodiment of this application, S201 includes:

S201a: In a case a battery level indicated by the battery level state is greater than a threshold, control, by using the second control member, the second magnetic member to switch from the third state to the fourth state.

For example, in this embodiment of this application, S201 includes:

S201b: In a case that the response state indicates that a first input is received, control, by using the second control member, the second magnetic member to switch from the third state to the fourth state.

For example, in this embodiment of this application, S201 includes:

S201c: In a case that the location state indicates being in a preset safe location, control, by using the second control member, the second magnetic member to switch from the third state to the fourth state.

For example, in this embodiment of this application, S201 includes:

S201d: When the running state indicates that a target application is running, control, by using the second control member, the second magnetic member to switch from the third state to the fourth state.

It can be understood that a reason and an advantage of this embodiment of this application are the same as those of the above. Details are not described herein again.

For example, in this embodiment of this application, the electronic device may perform rotation training to detect whether the second magnetic member is in the third state. In a case that the second magnetic member is in the third state, the electronic device controls, by using the second control member, the first magnetic member to switch from the third state to the fourth state.

It can be understood that the electronic device may detect, through rotation training in a preset period, whether the electronic device is in the third state.

It can be understood that the electronic device needs to perform S201 and S202 only in the third state, to implement separation between the electronic device and the charger.

It can be understood that, in a case that the second magnetic member is in the third state, the electronic device is generally cooperating with the charger to perform charging; or the electronic device has completed charging but has not yet been unplugged from the charger.

It can be understood that, in a case that the second magnetic member is not in the third state, the second magnetic member may be in the fourth state (that is, the first magnetic member and the second magnetic member repel each other or are not attracted to each other), or in this case, the electronic device is in a free state, and does not need to cooperate with the charger.

Through rotation training, it may be detected whether the second magnetic member is in the third state, so that the electronic device and the charger can be separated from each other in a timely manner when necessary or required.

For example, in this embodiment of this application, S201 includes:

S201a: Control, by using the second control member, the second magnetic member to rotate, so that the second magnetic member switches from the third state to the fourth state.

For example, in this embodiment of this application, S201 includes:

S201b: Control, by using the second control member, the second magnetic member to flip, so that the second magnetic member switches from the third state to the fourth state.

For example, in this embodiment of this application, S201 includes:

S201c: Control, by using the second control member, the second magnetic member to demagnetize, so that the second magnetic member switches from the third state to the fourth state.

For example, in this embodiment of this application, the S201a includes the following S201a′:

S201a′: Control, by using the second control member, the second magnetic member to rotate a second target angle, so that the second magnetic member switches from the third state to the fourth state.

In the third state, a third magnetic portion of the second control member is in a third location, and a fourth magnetic portion of the second control member is in a fourth location. In the fourth state, the third magnetic portion moves to the fourth location by rotating the second target angle, and the fourth magnetic portion moves to the third location by rotating the second target angle.

It can be understood that the second magnetic member may be controlled by using the second control member to rotate the second target angle with a fixed value (for example, 30°, 60°, or 90°), so that the second magnetic member switches from the third state to the fourth state; or the second magnetic member may be controlled by using the second control member to rotate to a preset location, so that the second magnetic member switches from the third state to the fourth state.

The second control member controls the second magnetic member to rotate the second target angle, so that the second magnetic member switches from the third state to the fourth state. Therefore, the second control member can conveniently and stably perform switching adjustment on the state of the second magnetic member.

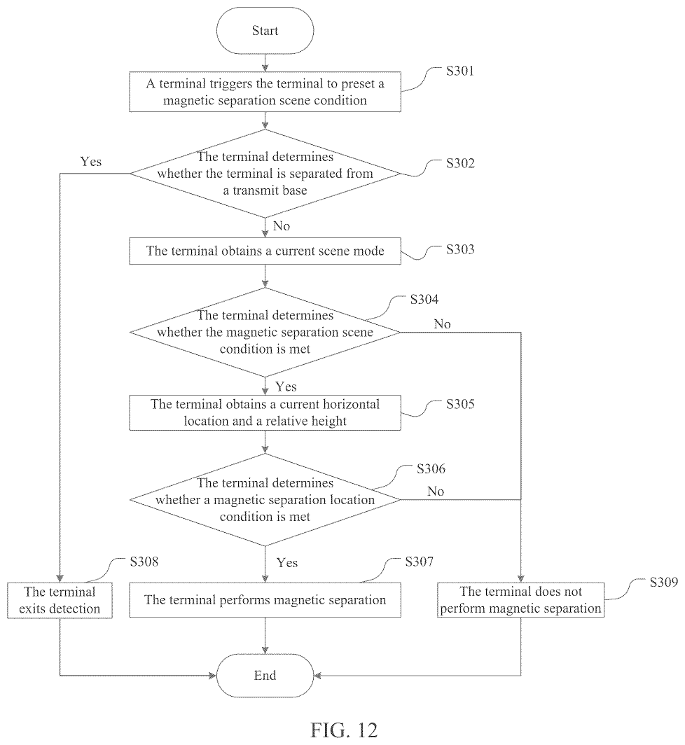

For example, in this embodiment of this application, as shown in FIG. 12, an embodiment of this application provides a control method for a terminal. The terminal may be an electronic device or a charger. The control method for a terminal is performed to control the electronic device in any one of the embodiments of this application or the terminal of the charger in any one of the embodiments of this application. The control method includes the following steps.

S301: A terminal triggers to preset a magnetic separation scene condition.

S302 is performed after S301.

For example, in this embodiment of this application, a user may trigger the terminal to set or change the magnetic separation scene condition.

S302: The terminal determines whether the terminal is separated from a transmit base.

If a determining result of S302 is yes, S308 is performed, or if a determining result of S302 is no, S303 is performed.

It can be understood that, if the terminal is separated from the transmit base, the terminal may exit detection. If the terminal is not separated from the transmit base, the terminal may continue to perform a detection determining process.

S303: The terminal obtains a current scene mode.

S304 is performed after S301.

For example, in this embodiment of this application, the current scene mode includes a state current use scene mode.

S304: The terminal determines whether the magnetic separation scene condition is met.

If a determining result of S304 is yes, S305 is performed, or if a determining result of S304 is no, S309 is performed.

For example, in this embodiment of this application, when the current use scene mode is a game program foreground running mode, a connected incoming call mode, or a video call mode, it may be determined that the magnetic separation scene condition is met.

S305: The terminal obtains a current horizontal location and a relative height.

S306 is performed after S305.

For example, in this embodiment of this application, the current horizontal location and the relative height may be collected by using an apparatus such as an infrared sensor or a ranging sensor.

S306: The terminal determines whether a magnetic separation location condition is met.

If a determining result of $306 is yes, S307 is performed; or if a determining result of S306 is no, S309 is performed.

S307: The terminal performs magnetic separation.

The procedure ends after S307.

S308: The terminal exits detection.

The procedure ends after S308.

S309: The terminal does not perform magnetic separation.

The procedure ends after S309.

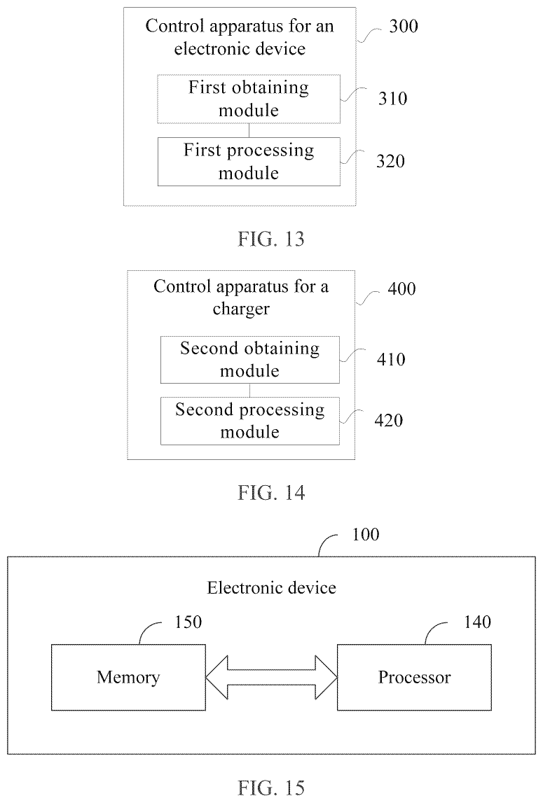

An embodiment of this application provides a control apparatus 300 for an electronic device, configured to control the electronic device in any one of the embodiments of this application. As shown in FIG. 13, the control apparatus 300 includes: a first obtaining module 310, where the first obtaining module 310 is configured to obtain a target state of the electronic device; and a first processing module 320, where the first processing module 320 is configured to: in a case that the target state obtained by the first obtaining module 310 meets a preset condition, control, by using a first control member, a first magnetic member to switch from a first state to a second state.

For example, in this embodiment of this application, the target state includes at least one of the following: a battery level state, a response state, a location state, and a running state. The first processing module 320 is configured to: in a case that a battery level indicated by the battery level state obtained by the first obtaining module 310 is greater than a threshold, control, by using the first control member, the first magnetic member to switch from the first state to the second state; or in a case that the response state obtained by the first obtaining module 310 indicates that a first input is received, control, by using the first control member, the first magnetic member to switch from the first state to the second state; or in a case that the location state obtained by the first obtaining module 310 indicates being in a preset safe location, control, by using the first control member, the first magnetic member to switch from the first state to the second state; or in a case that the running state obtained by the first obtaining module 310 indicates that a target application is running, control, by using the first control member, the first magnetic member to switch from the first state to the second state.

For example, in this embodiment of this application, the first processing module 320 is configured to: control, by using the first control member, the first magnetic member to rotate, so that the first magnetic member switches from the first state to the second state: or control, by using the first control member, the first magnetic member to flip, so that the first magnetic member switches from the first state to the second state; or control, by using the first control member, the first magnetic member to demagnetize, so that the first magnetic member switches from the first state to the second state.

For example, in this embodiment of this application, the first processing module 320 is configured to control, by using the first control member, the first magnetic member to rotate a first target angle, so that the first magnetic member switches from the first state to the second state; and a first magnetic portion of the first control member is in a first location and a second magnetic portion of the first control member is in a second location in the first state, and the first magnetic portion moves to the second location by rotating the first target angle and the second magnetic portion moves to the first location by rotating the first target angle in the second state.

The control apparatus 300 for an electronic device provided in this embodiment of this application can implement the control method for an electronic device in any one of the embodiments of this application, and therefore has all effects of the control method for an electronic device in any one of the embodiments of this application.

An embodiment of this application provides a control apparatus 400 for a charger, configured to control the charger in any one of the embodiments of this application. As shown in FIG. 14, the control apparatus 400 includes: a second obtaining module 410, where the second obtaining module 410 is configured to obtain a target state of an electronic device that cooperates with the charger; and a second processing module 420, where the second processing module 420 is configured to: in a case that the target state obtained by the second obtaining module 410 meets a preset condition, control, by using a second control member, a second magnetic member to switch from a third state to a fourth state. For example, in this embodiment of this application, the target state includes at least one of the following: a battery level state, a response state, a location state, and a running state. The second processing module 420 is configured to: in a case that a battery level indicated by the battery level state obtained by the second obtaining module 410 is greater than a threshold, control, by using the second control member, the second magnetic member to switch from the third state to the fourth state; or in a case that the response state obtained by the second obtaining module 410 indicates that a first input is received, control, by using the second control member, the second magnetic member to switch from the third state to the fourth state; or in a case that the location state obtained by the second obtaining module 410 indicates being in a preset safe location, control, by using the second control member, the second magnetic member to switch from the third state to the fourth state; or in a case that the running state obtained by the second obtaining module 410 indicates that a target application is running, control, by using the second control member, the second magnetic member to switch from the third state to the fourth state.

For example, in this embodiment of this application, the second processing module 420 is configured to: control, by using the second control member, the second magnetic member to rotate, so that the second magnetic member switches from the third state to the fourth state; or control, by using the second control member, the second magnetic member to flip, so that the second magnetic member switches from the third state to the fourth state; or control, by using the second control member, the second magnetic member to demagnetize, so that the second magnetic member switches from the third state to the fourth state.

For example, in this embodiment of this application, the second processing module 420 is configured to control, by using the second control member, the second magnetic member to rotate a second target angle, so that the second magnetic member switches from the third state to the fourth state; and a third magnetic portion of the second control member is in a third location and a fourth magnetic portion of the second control member is in a fourth location in the third state, and the third magnetic portion moves to the fourth location by rotating the second target angle and the fourth magnetic portion moves to the third location by rotating the second target angle in the fourth state.

The control apparatus 400 for a charger provided in this embodiment of this application can implement the control method for the charger in any one of the embodiments of this application, and therefore has all effects of the control method for the charger in any one of the embodiments of this application.

As shown in FIG. 15, an embodiment of this application provides an electronic device 100, including a processor 140, a memory 150, and a program or an instruction that is stored in the memory 150 and that can be run on the processor 140, where the program or the instruction is executed by the processor to implement the steps of the control method in any one of the embodiments of this application, or the steps of the control method in any one of the embodiments of this application.

It should be noted that the electronic device 100 in this embodiment of this application may be a mobile electronic device, or may be a non-mobile electronic device.

The electronic device 100 provided in this embodiment of this application can implement the control method for an electronic device in any one of the embodiments of this application, and therefore has all effects of the control method for an electronic device in any one of the embodiments of this application.

An embodiment of this application provides a readable storage medium, where a program or an instruction is stored on the readable storage medium, and the program or the instruction is executed by a processor to implement the steps of the control method in any one of the embodiments of this application, or the steps of the control method in any one of the embodiments of this application.

The processor is the processor in the electronic device in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing control method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

In descriptions in this specification, descriptions about such reference terms as “an embodiment”, “some embodiments”, “schematic embodiment”, “an example”, “a specific example”, and “some examples” mean that specific features, structures, materials, or characteristics described with reference to the embodiments or examples are included in at least one embodiment or example of this application. In this specification, the foregoing example expressions of the terms are not necessarily with respect to a same embodiment or example. In addition, the described specific features, structures, materials, or characteristics may be combined in a proper manner in any one or more of the embodiments or examples.

Although the embodiments of this application have been illustrated and described, a person of ordinary skill in the art can understand that various changes, modifications, replacements, and variants may be made to these embodiments without departing from the principle and purpose of this application, and the scope of this application is limited by the claims and their equivalents.

1. An electronic device, comprising:
a first magnetic member comprising a first magnetic portion and a second magnetic portion, wherein the first magnetic portion is different from the second magnetic portion; and
a first control member configured to control the first magnetic member to switch between a first state and a second state, wherein
when the first magnetic member is in the first state, the first magnetic member and a second magnetic member of a charger are attracted to each other, and when the first magnetic member is in the second state, the first magnetic member and the second magnetic member are separated from each other.

2. The electronic device according to claim 1, wherein
when the first magnetic portion is a south magnetic pole, the second magnetic portion is a north magnetic pole; or
when the first magnetic portion is in a magnetized state, the second magnetic portion is in a demagnetized state.

3. The electronic device according to claim 1, further comprising:
a first charging coil, wherein the first magnetic portion and the second magnetic portion are disposed at intervals around the first charging coil.

4. A control method for an electronic device, comprising:
obtaining a target state of the electronic device; and
controlling, by using a first control member of the electronic device when the target state meets a preset condition, a first magnetic member of the electronic device to switch from a first state to a second state, wherein:
when the first magnetic member is in the first state, the first magnetic member and a second magnetic member of a charger are attracted to each other, and when the first magnetic member is in the second state, the first magnetic member and the second magnetic member are separated from each other.

5. The control method for the electronic device according to claim 4, wherein:
the target state comprises at least one of the following: a battery level state, a response state, a location state, or a running state; and
the controlling, by using a first control member of the electronic device when the target state meets a preset condition, a first magnetic member of the electronic device to switch from a first state to a second state comprises:
when a battery level indicated by the battery level state is greater than a threshold, controlling, by using the first control member, the first magnetic member to switch from the first state to the second state; or
when the response state indicates that a first input is received, controlling, by using the first control member, the first magnetic member to switch from the first state to the second state; or
when the location state indicates being in a preset safe location, controlling, by using the first control member, the first magnetic member to switch from the first state to the second state; or
when the running state indicates that a target application is running, controlling, by using the first control member, the first magnetic member to switch from the first state to the second state.

6. The control method for the electronic device according to claim 4, wherein the controlling, by using a first control member of the electronic device when the target state meets a preset condition, a first magnetic member of the electronic device to switch from a first state to a second state comprises:
controlling, by using the first control member, the first magnetic member to rotate, so that the first magnetic member switches from the first state to the second state; or
controlling, by using the first control member, the first magnetic member to flip, so that the first magnetic member switches from the first state to the second state; or
controlling, by using the first control member, the first magnetic member to demagnetize, so that the first magnetic member switches from the first state to the second state.

7. The control method for the electronic device according to claim 6, wherein the controlling, by using the first control member, the first magnetic member to rotate, so that the first magnetic member switches from the first state to the second state comprises:
controlling, by using the first control member, the first magnetic member to rotate a first target angle, so that the first magnetic member switches from the first state to the second state; and
a first magnetic portion of the first control member is in a first location and a second magnetic portion of the first control member is in a second location in the first state, and the first magnetic portion moves to the second location by rotating the first target angle and the second magnetic portion moves to the first location by rotating the first target angle in the second state.

8. An electronic device, comprising a processor; and a memory having a computer program or an instruction stored thereon, wherein the computer program or the instruction, when executed by the processor, causes the processor to implement operations, comprising:
obtaining a target state of the electronic device; and
controlling, by using a first control member of the electronic device when the target state meets a preset condition, a first magnetic member of the electronic device to switch from a first state to a second state, wherein:
when the first magnetic member is in the first state, the first magnetic member and a second magnetic member of a charger are attracted to each other, and when the first magnetic member is in the second state, the first magnetic member and the second magnetic member are separated from each other.

9. The electronic device according to claim 8, wherein:
the target state comprises at least one of the following: a battery level state, a response state, a location state, or a running state; and
the controlling, by using a first control member of the electronic device when the target state meets a preset condition, a first magnetic member of the electronic device to switch from a first state to a second state comprises:
when a battery level indicated by the battery level state is greater than a threshold, controlling, by using the first control member, the first magnetic member to switch from the first state to the second state; or
when the response state indicates that a first input is received, controlling, by using the first control member, the first magnetic member to switch from the first state to the second state; or
when the location state indicates being in a preset safe location, controlling, by using the first control member, the first magnetic member to switch from the first state to the second state; or
when the running state indicates that a target application is running, controlling, by using the first control member, the first magnetic member to switch from the first state to the second state.

10. The electronic device according to claim 8, wherein the controlling, by using a first control member of the electronic device when the target state meets a preset condition, a first magnetic member of the electronic device to switch from a first state to a second state comprises:
controlling, by using the first control member, the first magnetic member to rotate, so that the first magnetic member switches from the first state to the second state; or
controlling, by using the first control member, the first magnetic member to flip, so that the first magnetic member switches from the first state to the second state; or
controlling, by using the first control member, the first magnetic member to demagnetize, so that the first magnetic member switches from the first state to the second state.

11. The electronic device according to claim 10, wherein the controlling, by using the first control member, the first magnetic member to rotate, so that the first magnetic member switches from the first state to the second state comprises:
controlling, by using the first control member, the first magnetic member to rotate a first target angle, so that the first magnetic member switches from the first state to the second state; and
a first magnetic portion of the first control member is in a first location and a second magnetic portion of the first control member is in a second location in the first state, and the first magnetic portion moves to the second location by rotating the first target angle and the second magnetic portion moves to the first location by rotating the first target angle in the second state.
